(19) United States
(12) Patent Application Publication
(10) Pub. No.: US 2021/0396057 A1
(43) Pub. Date: Dec. 23, 2021

(54) FOLDBACK DOOR AND SYSTEM

(71) Applicant: CENTOR DESIGN PTY LTD, Queensland (AU)

(72) Inventor: Nigel Frank SPORK, Queensland (AU)

(21) Appl. No.: 17/281,491

(22) PCT Filed: Oct. 18, 2019
(86) PCT No.: PCT/AU2019/051136

§ 371 Date: Mar. 30, 2021

(30) Foreign Application Priority Data
Oct. 24, 2018 (AU) 2018904040

(51) Int. Cl. E05D 15/26; E06B 3/48

(52) U.S. Cl. CPC E05D 15/266; E05D 15/58; E06B 3/481

(57) ABSTRACT

A foldback door system for at least partially closing an opening having at least one plane, the system including at least two mutually pivoted panels movable between a closed condition relative to a frame having at least one jamb relative to which the at least two mutually pivoted panels are hung, the at least two panels including a lateral panel located closer to the jamb and an inner panel hinged relative to the lateral panel and the frame, the lateral panel being of a first dimension and the inner panel being of a second dimension different to the first dimension, the closed condition in which the at least two panels are in substantial alignment to at least partially close the opening and a fully open, foldback condition in which the at least two panels are substantially parallel with one another and lie at an angle of greater than 90° with respect to the at least one plane of the opening in which the at least two panels lie in the closed condition.

### TECHNICAL FIELD

The present invention relates generally to the field of doors and windows and particularly to a set of foldback doors or windows or bifold doors or windows that have asymmetric panels and foldback further than 90° from the closed position.

### BACKGROUND ART

Foldback doors or bifold doors are commercially available as are foldback windows or bifold windows.

One configuration is disclosed in International Patent Publication No. WO2009/145641. This document discloses a closure assembly (such as a door or window) with at least two pivoted movable panels. When the panels are opened, they lie at an acute angle or parallel with respect to the plane of the opening. The panels in this document are equal in size to one another.

Another configuration is disclosed in U.S. Pat. No. 4,295,514. This document discloses a bifold door assembly comprising of two door panels of equal width. The panels are joined by hinges which permit the door panels to be opened to an obtuse position (greater than 90 degrees).

A further configuration is disclosed in United States Patent Publication No. US2006/0108079 which discloses an arrangement for bifold panel structures (door or window or a hybrid of both) with at least two mutually pivoted panels of the same dimension. The panels are movable and in an opened condition, at least two panels are substantially clear of the plane of the opening. One of each panel or at least two panels lie at an acute angle or parallel with respect to the plane of the opening.

Foldback doors or bifold doors which have asymmetric panels are also available with one example disclosed in U.S. Pat. No. 6,470,952. This document shows a powered, automated door system and more particularly to a laterally symmetrical, bi-folding door assembly having four folding panels comprising a jamb panel and a general central panel to each side of the centre of the door opening. The glass panels are in different widths with the two middle panels being wider in width than the outer panels.

A second example of foldback doors or bifold doors which have asymmetric panels is disclosed in U.S. Pat. No. 4,534,395.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a foldback door and system, which may at least partially overcome at least one of the abovementioned disadvantages or provide the consumer with a useful or commercial choice.

With the foregoing in view, the present invention in one form, resides broadly in a foldback door system for at least partially closing an opening having at least one plane, the system including at least two mutually pivoted panels movable between a closed condition relative to a frame having at least one jamb relative to which the at least two mutually pivoted panels are hung, the at least two panels including a lateral panel located closer to the jamb and an inner panel hinged relative to the lateral panel and the frame, the lateral panel being of a first dimension and the inner panel being of a second dimension different to the first dimension, the closed condition in which the at least two panels are in substantial alignment to at least partially close the opening and a fully open, foldback condition in which the at least two panels are substantially parallel with one another and lie at an angle of greater than 90° with respect to the at least one plane of the opening in which the at least two panels lie in the closed condition.

To date, the window and door industry has avoided unequal sized panels because it is easier to manufacture doors with equal sized panels. However, as will be seen from the following discussion, the unequal sized panels provide the present invention with distinct advantages, particularly in the provision of the opening when the door panels are in the open position, and the door panels also look better closed.

The system of the present invention will preferably be a bifold foldback door system but more than two panels can be used in any panel assembly.

The foldback door system of the present invention will preferably fold back to greater than 90°, preferably greater than 100° and most preferably approximately 135°.

Although the present invention is described primarily with reference to foldback door systems, it will be apparent to a person skilled in the art that the present invention can be adapted for use with foldback window systems and/or shutter systems as well as to systems including more than two panels in a panel assembly.

Further, the system of the present invention is preferably used for an opening having a single plane (a linear embodiment) but the system of the present invention may be utilised for an opening located at a corner of a structure whether the corner is a perpendicular corner or at an angle other than perpendicular. In situations where the system is utilised to close an opening located at a corner, an appropriate configuration will preferably be provided at the abutment between the panels of different sets or between a panel and a jamb.

The system of the present invention will preferably include a surround frame, typically manufactured from one or more members connected together in order to form the surround frame. Typically, a pair of bifold panel assemblies are located relative to the frame in order to close an opening defined by the frame. Normally, each of the pair of bifold panel assemblies will span approximately half of the opening when closed.

Preferably, the surround frame will include at least one head member, at least one opposed sill member and at least one jamb member located on each lateral side of the surround frame between the at least one head member and the at least one sill member in order to define a substantially rectangular surround frame.

Generally, each of the bifold panel assemblies will have both upper and lower guide mechanisms or assemblies in order to guide movement of the panels during the opening and closing actions. The guide mechanisms or assemblies may be as simple as a gutter or similar channel provided relative to each of the head member(s) and the sill member(s) relative to which a guide or carrier assembly provided on at least one of the panels can move. The guide or carrier assemblies may be simple or complex, for example, potentially including one or more rollers in order to allow easier movement but, the guide or carrier assemblies may include guide blocks or slide blocks for example.

As mentioned above, the surround frame is typically generally rectangular and will preferably define an opening with the opening having a plane and the panels will typically be oriented in the plane when in the closed condition. In this way, the window or door system of the present invention can separate two areas when the panels are closed and allow access between two areas when the panels are open. Typically, the panels will lie in the plane when the window or door assembly is closed and will be angled relative to the plane when the window or door assembly is open.

The system of the present invention includes at least two mutually pivoted panels. As mentioned above, generally two sets of two panels will be provided relative to the opening, normally divided into a pair of panels on the left-hand side of the opening and a pair of panels on the right-hand side of the opening. When closed, the panels will typically meet in the middle in order to close the opening.

In an alternative embodiment, two sets of more than two panels can be provided, with the panels in each set designated as a lateral panel, an inner panel and one or more intermediate panels located between the lateral panel and the inner panel in each set. In this configuration, the inner panel and the intermediate panels will preferably be wider than the lateral panel in each set, and preferably approximately the same width as each other.

Each set of panels is typically anchored relative to the respective jamb on the respective side of the surround frame. Each set of panels is typically configured with a lateral panel and an inner panel which is hinged relative to the lateral panel. Preferably, the lateral panel is fixed at least one side edge thereof relative to the respective jamb. Although this can be accomplished in many different ways, the lateral panel is typically provided with a top pivot and a bottom pivot located adjacent to the side edge of the lateral panel which is located adjacent to the jamb.

The inner panel is typically provided with at least one support and guide assembly and preferably, a support and guide assembly at or relative to an upper edge and a second support and guide assembly at or relative to a lower edge. In some embodiments, the support and guide assembly provided at or relative to an upper edge can differ in configuration to the support and guide assembly provided at or relative to the lower edge. For example, the support and guide assembly provided at or relative to the upper edge can be more complex in configuration and include one or more rollers in order to support the weight of the inner panel and/or lateral panel with the support and guide assembly provided at or relative to the lower edge being more simplistic. The system could also be made with bottom rolling hardware, where the weight of the panel is taken on a bottom carrier, not a top carrier or weight bearing carriers can be provided at both the top and the bottom.

Preferably, the inner panel can pivot relative to the frame typically at the side edge of the inner panel opposite to the lateral panel. In a particularly preferred embodiment, the pivot allowing the inner panel to pivot relative to the frame is provided as a part of the support and guide assembly at each of the upper and lower sides of the inner panel.

During opening and closing, the lateral panel will typically pivot about the upper and lower pivots adjacent to the respective jamb, the inner panel will typically fold relative to the lateral panel about the hinges provided between the lateral panel and the inner panel, and the inner panel will also pivot about the support and guide assemblies whilst the inner side edge of the inner panel translates, typically linearly towards the jamb relative to which it is mounted until the inner panel and lateral panel are substantially parallel to one another.

As mentioned above, it is preferred that the panels are provided in pairs or sets of two panels, with one lateral panel and one inner panel provided in each pair or set of panels. The width of the lateral panel is preferably a first dimension and the width of the inner panel is preferably a second dimension with the first dimension being different to the second dimension. Usually, the width of the lateral panel is smaller than the width of the inner panel. The lateral panel and inner panel are preferably the same height, and configured to substantially extend over the height of the opening within the surround frame. This configuration will typically create asymmetrically sized panels in terms of width.

Whilst not wishing to be limited by theory, the asymmetrically sized panels will preferably create a mismatch such that as the inner panel and lateral panel in a pair or set of panels is moved from the closed condition to the open condition, the configuration and/or mounting of the panels will preferably cause the panels to fold back to an angle of greater than 90° relative to the plane of the opening.

Typically, the relative sizes or widths of the inner panel compared to the lateral panel will preferably determine the fold back angle as the guide assemblies on the inner panel can only move in a linear direction laterally and the inner panel is hinged to the lateral panel.

Preferably, the support and guide assembly(ies) of the inner panel is substantially coplanar at all times with the pivot(s) of the lateral panel.

Preferably, the support and guide assembly(ies) provided on the inner panel are located relative to an end edge of the inner panel furthest from the jamb relative to which the pair or set of panels is mounted. This end edge will typically be the end edge which is located toward the midline of the opening when the pair or set of panels is in the closed condition.

As mentioned above, any type of support and guide assembly may be used and the support and guide assembly provided at or relative to the upper edge of the inner panel may be different to the supporting guide assembly provided at or relative to the lower edge of the inner panel but preferably, the supporting guide assembly(ies) are adapted to linear translation only although the support and guide assembly(ies) will also typically allow the end edge of the inner panel to pivot relative thereto.

As mentioned above, one or more hinges are typically provided between the lateral panel and the inner panel. Any type of hinge may be provided and any number of hinges may be provided. For example, one or more conventional butt hinges may be used or one or more offset hinges may be used. Preferably, a number of hinges are provided spaced apart over the height of the pair or set of panels.

The foldback door system of the present invention provides a number of benefits over traditional bifold doors including:
More glass in the centre of the door assembly for improved views;
The different dimension panels make the door assembly resemble a traditional French door with sidelites although they function as a bifold door assembly;
When the doors are in the open position, the doors do not obstruct the clear view and a larger visible area is created; and
Traffic flow around the doors is not as impeded in the way that it is when the doors are oriented at approximately 90° to the plane of the opening.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a view from the front of a bifold foldback door assembly of a preferred embodiment of the present invention.

FIG. 2 is a schematic view from above of a bifold foldback door assembly according to a preferred embodiment with the head member removed for clarity, the assembly having asymmetric sized panels and a straight hinge between the panels.

FIG. 3 is a schematic view from above of a bifold foldback door assembly according to a preferred embodiment with the head member removed for clarity, the assembly having asymmetric sized panels and an offset hinge between the panels.

FIG. 4 is a detailed view of one side of a prior art bifold foldback door system configuration with the same width panels and a butt hinge.

FIG. 5 is a detailed view of one side of a bifold foldback door system configuration with the same width panels and an offset hinge showing a small degree of foldback achievable using an offset hinge.

FIG. 6 is a schematic view from above of a foldback door assembly for a corner opening according to a preferred embodiment with the head member removed for clarity, the assembly having asymmetric sized panels and an offset hinge between the lateral and intermediate panels and in the closed condition.

FIG. 7 is a schematic view of the configuration shown in FIG. 6 in the open condition.

FIG. 8 is a schematic view from above of a foldback door assembly according to a preferred embodiment with the head member removed for clarity, the assembly having asymmetric sized panels and an offset hinge between the lateral and intermediate panels and in the closed condition.

FIG. 9 is a schematic view of the configuration shown in FIG. 8 in the open condition.

### DESCRIPTION OF EMBODIMENTS

According to a particularly preferred embodiment of the present invention, a bifold foldback door assembly is provided.

The bifold foldback door assembly 10 illustrated in the accompanying Figures is configured for at least partially closing an opening 11 defined in a surround frame 12. The assembly includes two bifold panel assemblies 13, each of two mutually pivoted panels movable between a closed condition relative to the surround frame 12 in which the panels in each bifold panel assembly 13 are aligned and substantially coplanar with each other to at least partially close the opening 11 and a fully open, foldback condition in which the panels in each bifold panel assembly 13 are substantially parallel with one another and lie at an angle of greater than 90° with respect to the plane of the opening 11.

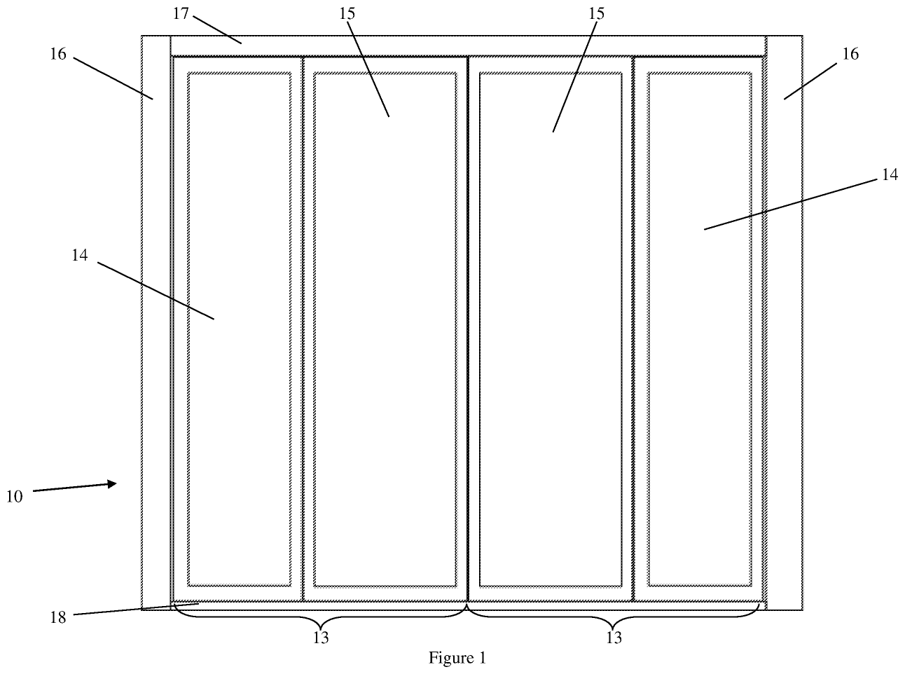

As shown in FIG. 1 in particular, each of the bifold panel assemblies 13 includes a lateral panel 14 located closer to the jamb 16 and an inner panel 15 pivotally mounted relative to the lateral panel 14 and a head member 17 and sill member 18 of the surround frame 12, the lateral panel 14 being of a lesser width than the inner panel 15.

The bifold foldback door system of the present invention will preferably fold back to greater than 90°, preferably greater than 100° and most preferably approximately 135° although this will depend as will be explained below.

The surround frame 12 is typically manufactured from a head 17, an opposed sill 18 and a jamb 16 located on each lateral side of the surround frame 12 between the head 17 and the sill 18 in order to define a substantially rectangular surround frame 12. Typically, a pair of bifold panel assemblies 13 are located relative to the frame 12 in order to close the opening 11 defined by the frame 12. As shown, each of the pair of bifold panel assemblies 13 spans approximately half of the opening 11 when closed.

Generally, each of the bifold panel assemblies 13 will have both upper and lower guide mechanisms or assemblies in order to guide movement of the panels during the opening and closing actions. The guide mechanisms or assemblies may be as simple as a gutter or similar channel provided relative to each of the head member(s) and the sill member(s) relative to which a guide or carrier assembly provided on at least one of the panels can move. The guide or carrier assemblies may be simple or complex, for example, potentially including one or more rollers in order to allow easier movement but, the guide or carrier assemblies may include guide blocks or slide blocks for example.

As mentioned above, the surround frame is typically generally rectangular and will preferably define an opening with the opening having a plane and the panels will typically be oriented in or parallel to the plane when in the closed condition. Typically, the panels in any assembly 10 will all be aligned and coplanar when closed.

As mentioned above, generally two bifold panel assemblies 13, each of two panels are provided relative to the opening 11, normally divided into a pair of panels on the left-hand side of the opening 11 and a pair of panels on the right-hand side of the opening 11. When closed, the panels of the bifold panel assemblies 13 will typically meet in the middle in order to close the opening 11 as shown in FIG. 1.

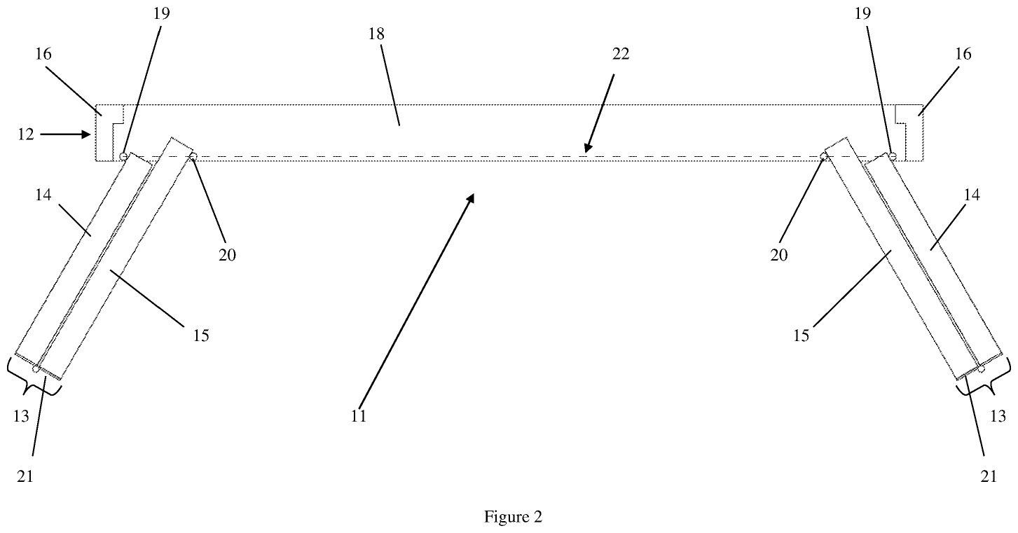

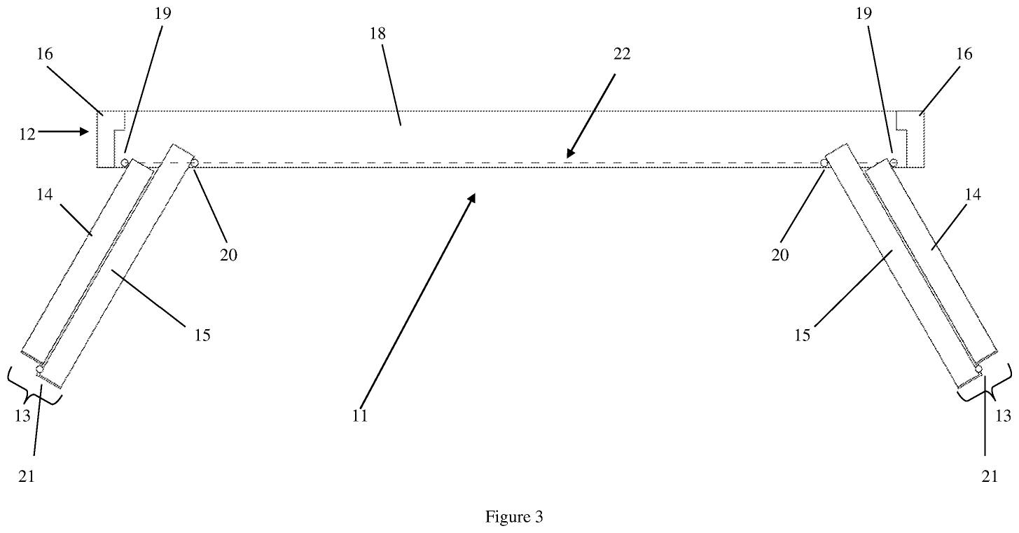

Each bifold panel assembly 13 is typically anchored relative to the respective jamb 16 on the respective side of the surround frame 12. Each bifold panel assembly 13 is typically configured with a lateral panel 14 and an inner panel 15 which is hinged relative to the lateral panel 14. The lateral panel 14 in each bifold panel assembly 13 is fixed at an outer side edge thereof relative to the respective jamb 16. Although this can be accomplished in many different ways, the lateral panel 14 is typically provided with a top pivot 19 (in FIGS. 2 and 3) and a bottom pivot (obscured in FIGS. 2 and 3) located adjacent to the outer side edge of the lateral panel 14 which is located adjacent to the jamb 16.

The inner panel 15 is typically provided with at least one support and guide assembly and preferably, a support and guide assembly at or relative to an upper edge 20 (in FIGS. 2 and 3) and a second support and guide assembly at or relative to a lower edge (obscured in FIGS. 2 and 3).

The inner panel 15 can pivot relative to the frame 12 at the inner side edge of the inner panel 15 (opposite to the side edge hinged to the lateral panel 14). The pivot allowing the inner panel 15 to pivot relative to the frame 12 is provided as a part of the support and guide assembly at each of the upper and lower sides of the inner panel 15.

During opening and closing, the lateral panel 14 will pivot about the upper and lower pivots adjacent to the respective jamb 16, the inner panel 15 will typically fold relative to the lateral panel 14 about the hinges 21 provided between the lateral panel 14 and the inner panel 15 and the inner panel 15 will also pivot about the support and guide assemblies whilst the inner side edge of the inner panel 15 translates, typically linearly (along line 22 shown in FIGS. 2 and 3) towards the jamb 16 relative to which it is mounted until the inner panel 15 and lateral panel 14 are substantially parallel to one another.

As mentioned above, it is preferred that the panels are provided in a bifold panel assembly 13 including two panels, with one lateral panel 14 and one inner panel 15 provided in each bifold panel assembly 13. The width of the lateral panel 14 is preferably smaller than the width of the inner panel 15. The lateral panel 14 and inner panel 15 are preferably the same height, and configured to substantially extend over the height of the opening 11 within the surround frame 12. This configuration will typically create asymmetrically sized panels in terms of width.

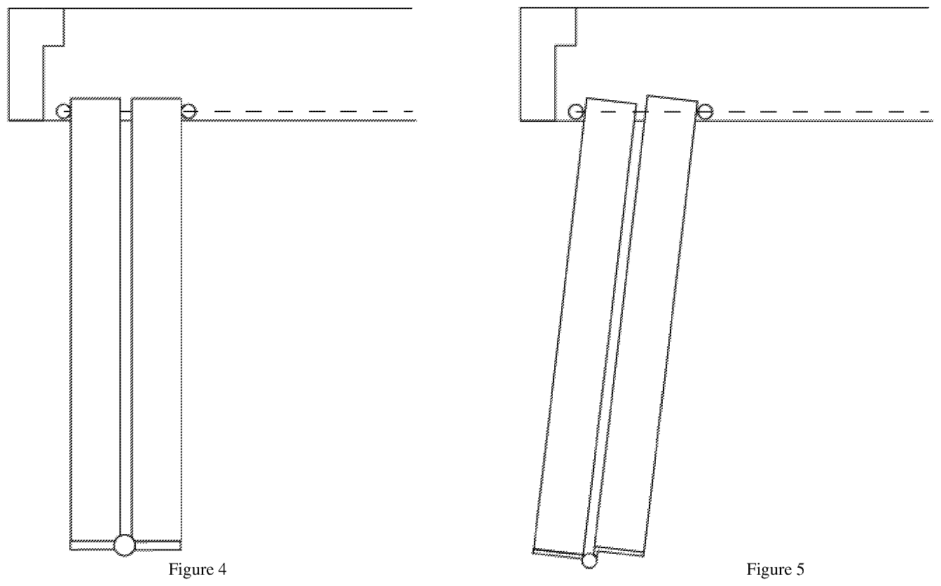

Whilst not wishing to be limited by theory, the asymmetrically sized panels create a mismatch such that as the inner panel 15 and lateral panel 14 in a bifold panel assembly 13 is moved from the closed condition to the open condition, the configuration and/or mounting of the inner panel 15 and lateral panel 14 cause the inner panel 15 and lateral panel 14 to fold back to an angle of greater than 90° relative to the plane of the opening 11 as illustrated in FIGS. 2 and 3, in particular. This can be contrasted with the substantially perpendicular angle of the inner panel and lateral panel of the same width as shown in FIG. 4. Even with an offset hinge as shown in FIG. 5, an inner panel and lateral panel of the same width can only achieve slightly greater than 90° relative to the plane of the opening due the limitation on the movement of the inner panel and lateral panel of the same width.

Typically, the relative sizes or widths of the inner panel 15 compared to the lateral panel 14 will determine the fold back angle as the guide assemblies on the inner panel can only move in a linear direction laterally and the inner panel is hinged to the lateral panel.

Preferably, the support and guide assembly(ies) 20 of the inner panel 15 is/are substantially coplanar at all times with the pivot(s) 19 of the lateral panel 14.

Preferably, the support and guide assembly(ies) provided on the inner panel 15 is/are located relative to an end edge of the inner panel 15 furthest from the jamb 16 relative to which the bifold panel assembly 13 is mounted. This end edge will typically be the end edge which is located toward the midline of the opening when the bifold panel assembly 13 is in the closed condition.

As mentioned above, any type of support and guide assembly may be used and the support and guide assembly provided at or relative to the upper edge of the inner panel 15 may be different to the supporting guide assembly provided at or relative to the lower edge of the inner panel 15 but preferably, the supporting guide assembly(ies) are configured to linear translation only and the support and guide assembly(ies) will also typically allow the end edge of the inner panel 15 to pivot relative thereto.

As mentioned above, one or more hinges 21 are typically provided between the lateral panel 14 and the inner panel 15. Any type of hinge may be provided and any number of hinges may be provided. For example, one or more conventional butt hinges may be used as shown in FIG. 2 or one or more offset hinges may be used as shown in FIG. 3 with offset hinges potentially allowing a greater angle relative to the plane of the opening to be achieved at full open. Preferably, a number of hinges are provided spaced apart over the height of the pair or set of panels.

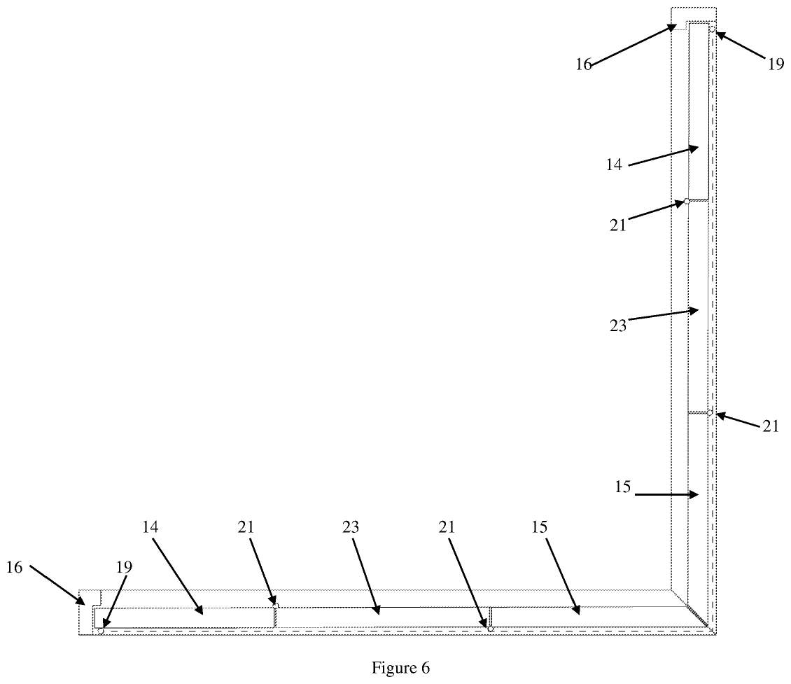

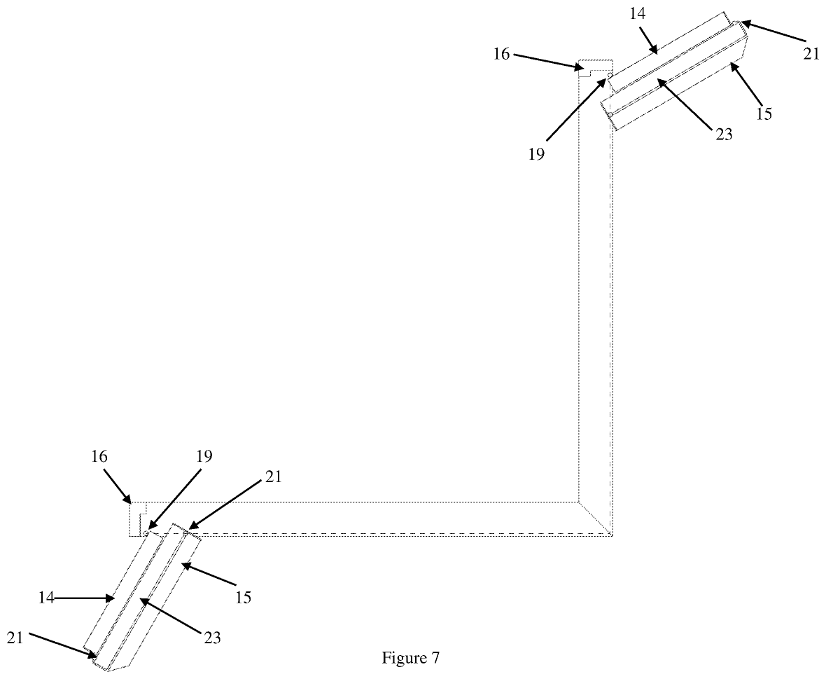

Illustrated in FIGS. 6 and 7 is an embodiment of the system of the present invention used to close a corner opening. As illustrated, there are two panel sets, one along each planar portion of the corner opening, with each set including three panels, a lateral panel 14 mounting the respective panel set relative to a jamb 16, an inner panel 15 and an intermediate panel 23. An upper pivot 19 is provided adjacent to each jamb and a pair of hinges 21 are provided in each panel set between the panels. At least one of the hinges also includes an upper and/or lower guide mechanism or assembly to guide the hinged panels in a linear direction between closed and open. As shown in FIG. 7, the inner panel 15 and the intermediate panel 23 of each set are wider than the lateral panel 14 and an offset hinge is used between the lateral panel 14 and the intermediate panel 23. The abutting edges of the respective inner panels is angled to allow abutment (and preferably sealing) when the panels are closed.

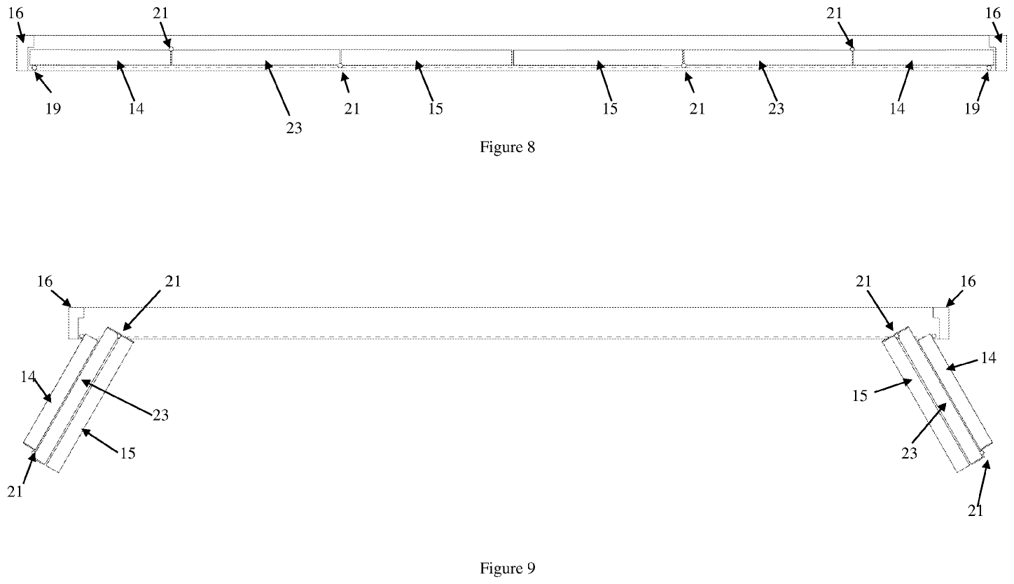

The configuration illustrated in FIGS. 8 and 9, is a linear embodiment of the system including two panel sets, with each set including three panels, a lateral panel 14 mounting the respective panel set relative to a jamb 16, an inner panel 15 and an intermediate panel 23. An upper pivot 19 is provided adjacent to each jamb and a pair of hinges 21 are provided in each panel set between the panels. At least one of the hinges also includes an upper guide to guide the hinged panels in a linear direction between closed and open. As shown in FIG. 9, the inner panel 15 and the intermediate panel 23 of each set are wider than the lateral panel 14 and an offset hinge is used between the lateral panel 14 and the intermediate panel 23.

In all illustrated embodiments, it is the provision of the the unequal panel widths with appropriate guides which create the fold back to greater than 90° with the provision of an offset hinge between the lateral panel and adjacent panel (whether an intermediate panel or an inner panel) also assisting with maximising the fold back angle which is created as the panels are moved to the open condition.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ or similar phrase means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A foldback door system for at least partially closing an opening having at least one plane, the system including at least two mutually pivoted panels movable between a closed condition relative to a frame having at least one jamb relative to which the at least two mutually pivoted panels are hung, the at least two panels including a lateral panel located closer to the jamb and an inner panel hinged relative to the lateral panel and the frame, the lateral panel being of a first dimension and the inner panel being of a second dimension different to the first dimension, the closed condition in which the at least two panels are in substantial alignment to at least partially close the opening and a fully open, foldback condition in which the at least two panels are substantially parallel with one another and lie at an angle of greater than 90° with respect to the at least one plane of the opening in which the at least two panels lie in the closed condition.

2. The foldback door system as claimed in claim 1, wherein the system is mounted to the opening, and the opening has a single plane, or wherein the opening is located at a corner of a structure whether the corner is a perpendicular corner or a tan angle other than perpendicular.

3. (canceled)

4. The foldback door system as claimed in claim 1, wherein the system further includes the frame, in the form of a surround frame, defining the opening.

5. The foldback door system as claimed in claim 4, wherein a pair of bifold panel assemblies are located relative to the surround frame in order to close the opening defined by the surround frame.

6. The foldback door system as claimed in claim 5, wherein each of the bifold panel assemblies include both upper and lower guide mechanisms or assemblies in order to guide movement of the panels during the opening and closing actions.

7. The foldback door system as claimed in claim 4, wherein the surround frame includes at least one head member, at least one opposed sill member and the at least one jamb member located on each lateral side of the surround frame between the at least one head member and the at least one sill member in order to define a substantially rectangular surround frame.

8. The foldback door system as claimed in claim 1, further including two sets of two mutually pivoted panels provided relative to the opening.

9. The foldback door system as claimed in claim 8, wherein one set of the two mutually pivoted panels include a pair of panels on the left-hand side of the opening and one set of the two mutually pivoted panels include a pair of panels on the right-hand side of the opening.

10. The foldback door system as claimed in claim 1, further including two sets of more than two panels, the panels in each set designated as a lateral panel, an inner panel and one or more intermediate panels located between the lateral panel and the inner panel in each set.

11. The foldback door system as claimed in claim 10, wherein the inner panel and the intermediate panels are wider than the lateral panel in each set, and approximately the same width as each other.

12. The foldback door system as claimed in claim 8, wherein each set of panels is anchored relative to a respective jamb.

13. The foldback door system as claimed in claim 12, wherein each set of panels is configured with a lateral panel and an inner panel which is hinged relative to the lateral panel.

14. The foldback door system as claimed in claim 13, wherein the lateral panel is fixed at least one side edge thereof relative to the respective jamb.

15. The foldback door system as claimed in claim 14, wherein the lateral panel is typically provided with a top pivot and a bottom pivot located adjacent to the side edge of the lateral panel.

16. The foldback door system as claimed in claim 15, wherein the inner panel is provided with at least one support and guide assembly.

17. The foldback door system as claimed in claim 16, wherein the support and guide assembly are provided at or relative to an upper edge of the inner panel and a second support and guide assembly at or relative to a lower edge of the inner panel.

18. The foldback door system as claimed in claim 17, wherein the support and guide assembly provided at or relative to an upper edge of the inner panel differs in configuration to the support and guide assembly provided at or relative to the lower edge of the inner panel.

19. The foldback door system as claimed in claim 16, wherein the inner panel pivots relative to the frame, in particular at the side edge of the inner panel opposite to the lateral panel.

20. (canceled)

21. The foldback door system as claimed in claim 19, wherein a pivot allowing the inner panel to pivot relative to the frame is provided as a part of the support and guide assembly at each of the upper and lower sides of the inner panel.

22. The foldback door system as claimed in claim 16, wherein during opening and closing, the lateral panel pivots about the upper and lower pivots adjacent to the respective jamb, the inner panel folds relative to the lateral panel about hinges provided between the lateral panel and the inner panel, and the inner panel pivots about the support and guide assemblies whilst the inner side edge of the inner panel translates, towards the jamb relative to which it is mounted until the inner panel and lateral panel are substantially parallel to one another.

23. The foldback door system as claimed in claim 13, wherein the width of the lateral panel is a first dimension and the width of the inner panel is a second dimension with the first dimension being different to the second dimension, in particular wherein the width of the lateral panel is smaller than the width of the inner panel.

24. (canceled)

25. The foldback door system as claimed in claim 23, wherein the configuration of the lateral panel and the inner panel is asymmetrically in terms of width.

26. The foldback door system as claimed in claim 25, wherein the asymmetrically sized panels create a mismatch such that as the inner panel and lateral panel in each pair or set of panels is moved from the closed condition to the open condition, the configuration and/or mounting of the panels causing the panels to fold back to an angle of greater than 90° relative to the plane of the opening.

27. The foldback door system as claimed in claim 16, wherein the at least one support and guide assembly of the inner panel is substantially coplanar at all times with the pivots of the lateral panel.

28. The foldback door system as claimed in claim 27, wherein the at least one support and guide assembly provided on the inner panel is located relative to an end edge of the inner panel furthest from the jamb relative to which the pair or set of panels is mounted.

29. The foldback door system as claimed in claim 28, wherein the end edge is the end edge which is located toward the midline of the opening when the pair or set of panels is in the closed condition.

30. The foldback door system as claimed in claim 1, wherein the foldback door system is a bifold foldback door system.

31. The foldback door system as claimed in claim 1, wherein the foldback door system folds back to an angle selected from the following: greater than 90°, greater than 180°; approximately 135°.

32. (canceled)

33. (canceled)
